(19) United States
(12) Patent Application Publication
(10) Pub. No.: US 2026/0180923 A1
(43) Pub. Date: Jun. 25, 2026

(54) ANALOG CROSSBAR INTEGRATED CIRCUIT (XBAR IC) CAPABILITIES AND CONTROL SYSTEMS FOR EFFICIENT SWITCHING

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/428,048

(22) Filed: Dec. 19, 2025

Related U.S. Application Data
(60) Provisional application No. 63/737,546, filed on Dec. 20, 2024.

(51) Int. Cl. H04L 49/101; H04L 1/00

(52) U.S. Cl. CPC H04L 49/101; H04L 1/0061

(57) ABSTRACT

A device includes a plurality of digital signal processors (DSPs) and analog crossbars in communication with the DSPs. The analog crossbars dynamically switch between multiple inputs and outputs and adjust configurations based on real-time feedback from the DSPs. The crossbars use amplification to enhance signal strength at input and output stages, ensuring signal integrity across long transmission paths or during multicasting and broadcasting operations. Real-time adaptive equalization optimizes performance in response to environmental changes or signal degradation. The crossbars facilitate system management traffic through out-of-band signaling and support failover with redundant paths to maintain communication during failures. Synchronization with DSPs or a switch controller is achieved through shared clock signals or IEEE 1588. These features enable efficient, high-speed data transmission while maintaining robust performance and reliability in dynamic network environments.

### RELATED APPLICATION

This application claims the benefit of U.S. Provisional Application No. 63/737,546, filed Dec. 20, 2024, the disclosure of which is incorporated herein by reference in its entirety.

The examples discussed in the present disclosure are related to analog crossbar integrated circuit capabilities and control systems for efficient switching.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some embodiments, a device includes a plurality of digital signal processors (DSPs) and analog crossbars operable to dynamically switch between multiple inputs and outputs. The crossbars are configured to adapt their operation based on real-time feedback from the DSPs, using metrics such as bit error rate (BER) and signal-to-noise ratio (SNR) to optimize performance. Signal amplification at input and output stages ensures data integrity over long distances and during operations such as multicasting and broadcasting. Adaptive amplification adjusts dynamically to counteract environmental factors, such as electromagnetic interference or traffic variations, maintaining robust signal quality.

In some embodiments, the device further includes redundant crossbars to support failover mechanisms, providing alternate paths for control and data traffic during hardware failures. Out-of-band (OOB) signaling facilitates system management traffic without impacting in-band (IB) data flow, enabling efficient synchronization, diagnostics, and configuration updates. The crossbars implement real-time adaptive equalization to respond dynamically to environmental changes or signal degradation, leveraging stored profiles for rapid reconfiguration during failover or traffic adjustments.

In some embodiments, the analog crossbars support synchronization with DSPs and a switch controller through shared clock signals or IEEE 1588, ensuring coherent operation across distributed systems. Integrated environmental monitoring allows the crossbars to proactively adjust performance to maintain reliability under varying conditions. The device may also include secure mechanisms for validating crossbar configurations and preventing unauthorized access, enhancing system integrity. These features collectively enable the device to provide high-speed, reliable, and adaptable performance for dynamic and demanding network environments.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including digital signal processors and analog crossbars.

FIG. 2 illustrates an example circuit diagram of a device that may be used for an analog crossbar.

FIG. 3 illustrates example architecture that may be used for an analog crossbar.

FIG. 4 illustrates an example process flow for an analog crossbar.

FIG. 5 illustrates an example communication system operable for an analog crossbar.

FIG. 6 illustrates a diagrammatic representation of a machine in the example form of a computing device within which a set of instructions, for causing the machine to perform any one or more of the methods discussed herein, may be executed.

FIG. 7A illustrates an example block diagram of a data center.

FIG. 7B illustrates an example switch device.

FIG. 7C illustrates an example switch device.

FIG. 7D illustrates an example switch device.

### DESCRIPTION

The systems and methods of the examples described below pertains to the field of high-speed network switches and so-called physical media dependent (PMD) devices with crossbar-based architectures. Modern networks often experience fluctuating traffic patterns and congestion, requiring dynamic and efficient allocation of crossbar resources. Traditional static or fixed-path routing techniques lack the flexibility to respond to real-time network demands, often leading to inefficient bandwidth utilization and increased latency.

Analog crossbars may have various functions such as control systems and signal optimization. In particular, analog crossbars may have various control mechanisms, out-of-band signaling, and/or redundancy.

Examples of the described herein will be explained with reference to the accompanying drawings.

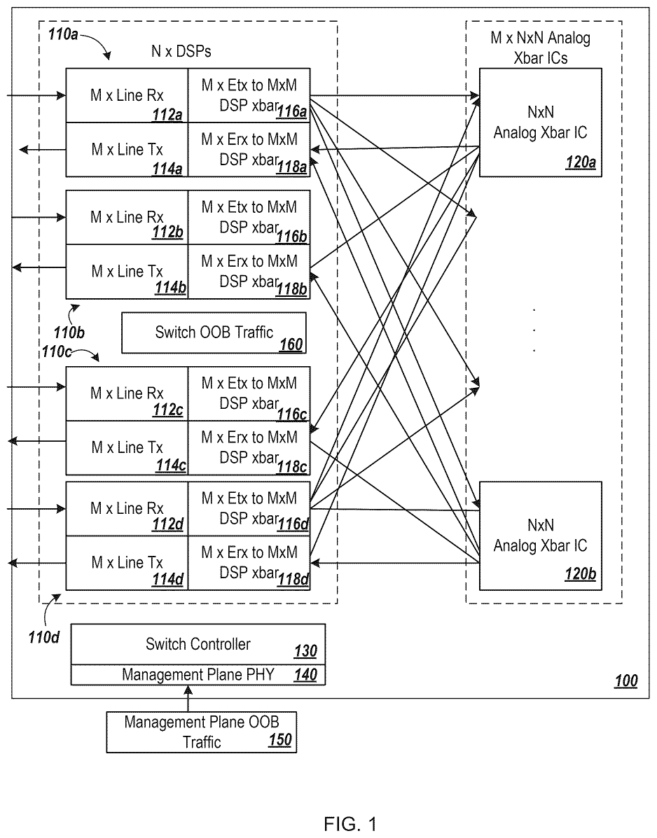

As illustrated in FIG. 1, an analog electrical circuit switch (AECS) 100 may include one or more digital signal processors (DSPs) 110a, 110b, 110c, 110d. The AECS 100 may include a switch controller 130. The AECS 100 may include one or more analog crossbars (“xbar”) integrated circuits (IC) (e.g., analog crossbars 120a, 120b).

DSPs 110a, 110b, 110c, 110d may be devices integrating layer 1 (L1) for line and switch side inputs and outputs. A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A PMD device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP 110a, 110b, 110c, 110d.

Switch out-of-band (OOB) traffic may be traffic among the SC 130, DSP 110a, 110b, 110c, 110d, analog crossbars 120a, 120b carried on a different network and physical layer than IB traffic. Switch OOB traffic may be carried on analog crossbars 120a, 120b with redundancy.

An “Xbar IC” may be an analog Xbar IC which may be a chip implementing an analog crossbar with input and output lanes.

Management plane OOB traffic may be traffic from outside the AECS 100 via management plane physical layer (PHY) to configure and manage the AECS 100.

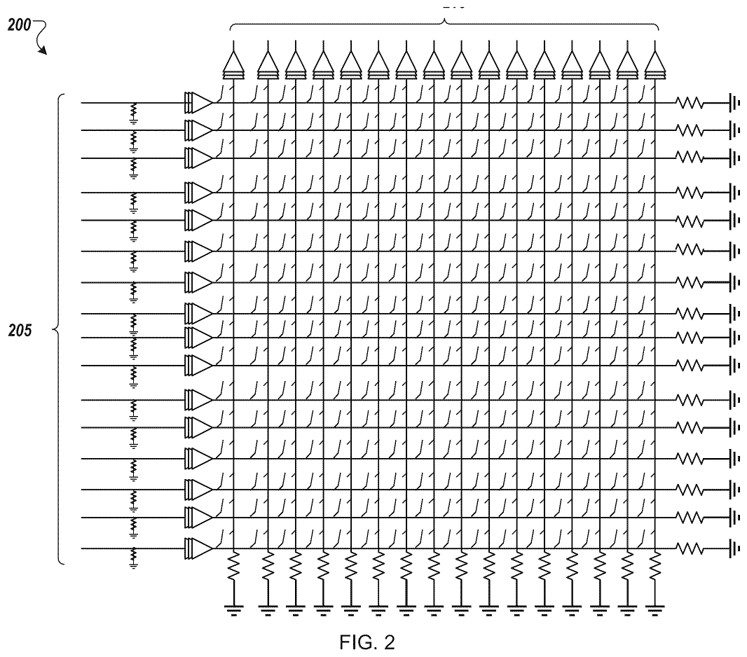

As illustrated in FIG. 2, a circuit 200 may be used with an analog crossbar. The circuit may include multiple inputs 205 (e.g., 16 inputs) and multiple outputs 210 (e.g., 16 outputs). A first input of multiple inputs 205 may be in communication with multiple outputs 210. A second input of multiple inputs 205 may be in communication with multiple outputs 210. An nth input of multiple inputs 205 may be in communication with multiple outputs 210. A first output of multiple outputs 210 may be in communication with multiple inputs 205. A second output of multiple outputs 210 may be in communication with multiple inputs 205. An nth output of multiple outputs 210 may be in communication with multiple inputs 205. Therefore, an input of multiple inputs 205 may be in communication with an output of multiple outputs 210, and an output of multiple outputs 210 may be in communication with multiple inputs 205.

A device may include DSPs and analog crossbars in communication with DSPs. The analog crossbars may switch between multiple inputs and multiple outputs. The analog crossbar ICs may support complex configurations for switching between multiple inputs and multiple outputs via analog signals.

Analog crossbars may determine a crossbar configuration for analog crossbars based on feedback from DSPs. For example, a DSP may provide feedback to the analog crossbar and the analog crossbar, in response, may be set to a specific crossbar configuration.

The analog crossbars may facilitate dynamic configuration adjustment based on a crossbar state. Incorporation of control systems may be used to manage the crossbar state, allowing dynamic configuration changes. The crossbar state may be set by an on-chip controller (e.g., a switch controller) or by an off-chip controller. Non-volatile memory may store the crossbar state and/or equalization.

In some embodiments, analog crossbars may use OOB signaling to facilitate system management traffic. OOB signaling in AECS 100/circuit 200 provides a robust mechanism for handling system management traffic while preserving IB bandwidth for data flows. By enabling dedicated, high-speed communication paths for control signals, OOB signaling reduces overhead, enhances system resilience, and supports advanced management functions. These capabilities improve the efficiency, reliability, and security of AECS 100 in diverse and demanding network environments. OOB signaling may be used to handle system management traffic without impacting in-band data flow. As a result, overhead may be reduced when compared to a baseline level of overhead when OOB signaling is not used, which is discussed in detail below.

Out-of-band (OOB) signaling, as illustrated in FIG. 1 and FIG. 2, is an advantageous mechanism for managing system-level communication in the AECS 100 without impacting the primary in-band (IB) data flow. By dedicating separate communication paths for OOB traffic, the system maintains efficient control and management operations while preserving IB bandwidth for data transmission. This separation reduces operational overhead and enhances overall system performance.

The analog crossbars 120a, 120b, shown in FIG. 1, integrate OOB transceivers designed for high-speed and low-latency communication. These transceivers, operating at speeds such as 10 Gbps SERDES or higher, facilitate system management tasks by providing dedicated channels for control signals between the switch controller 130 and the DSPs 110a, 110b, 110c, 110d. This design ensures that signaling, such as reconfiguration commands or performance monitoring updates, does not compete with IB traffic for resources.

In FIG. 2, circuit 200 demonstrates how OOB signaling is implemented across redundant crossbars. Each crossbar incorporates dedicated paths for OOB communication, allowing the switch controller 130 to maintain a continuous flow of management traffic even during failover or reconfiguration events. This capability is particularly beneficial for scenarios where rapid response times are used, such as fault detection or dynamic traffic routing.

OOB signaling reduces the risk of congestion within the system by offloading management traffic from IB channels. For example, updates to crossbar configurations, policy changes, or synchronization signals can be transmitted via OOB paths without interrupting ongoing data transfers. This design minimizes latency and ensures that IB bandwidth remains available for high-priority data flows.

The use of OOB signaling also enhances system resilience. By isolating control signals from IB traffic, the system maintains operational integrity even during periods of heavy data traffic or network congestion. This isolation ensures that the switch controller 130 can reliably issue commands and monitor system performance, enabling the AECS 100 to respond dynamically to changing network conditions.

OOB signaling supports advanced system management functions, such as synchronization, diagnostics, and firmware updates. For instance, OOB channels may be used to distribute clock synchronization signals across the crossbars and DSPs, ensuring coordinated operation. Similarly, diagnostic data collected from DSPs 110a, 110b, 110c, 110d can be transmitted via OOB paths to the switch controller 130 for analysis, facilitating proactive maintenance and performance optimization.

As depicted in FIG. 2, time-division multiplexing (TDM) may be implemented within OOB channels to manage multiple management tasks concurrently. TDM allows the switch controller 130 to allocate specific time slots for different types of management traffic, such as configuration updates or error reports. This structured approach ensures that all management tasks are handled efficiently without interference.

The integration of OOB signaling into redundant crossbars further enhances its utility. As illustrated in FIG. 1, separate redundant paths for OOB traffic ensure uninterrupted management communication during failover events. For example, when a primary OOB path becomes unavailable, the system automatically switches to a redundant path, allowing the switch controller 130 to maintain full control of the system.

Security is another advantage of OOB signaling. By isolating management traffic from IB data flows, the system reduces the risk of unauthorized access to control signals. OOB paths can also be secured using cryptographic protocols to authenticate communication between the switch controller 130 and other components, providing an additional layer of protection against tampering or interception.

Energy efficiency in OOB signaling can be achieved by dynamically adjusting the power levels of OOB transceivers based on traffic demand. During low-traffic periods, transceivers may operate in a low-power state while remaining ready to handle bursts of management traffic. This feature contributes to overall energy savings without compromising system responsiveness.

[symbol]

In some embodiments, analog crossbars and equalization configurations (e.g., continuous time linear equalization (CTLE)) may be controlled using OOB signaling. The analog integrated circuit may have an OOB transceiver such as a serial peripheral interface (SPI), an inter-integrated circuit (I2C), a serializer/deserializer (SERDES) e.g., 10 gigabits per second, or the like. Thus, the analog crossbar may be addressable via a protocol. The analog crossbar may incorporate OOB or IB communication to a network controller, e.g., a 10 gigabits per second that may use an available or redundant path. The OOB transceiver may use one or more of analog crossbar inputs and/or outputs such as one or more of R redundant inputs.

In some embodiments, analog crossbars support protocol translation layers within the DSPs 110a, 110b, 110c, 110d to ensure compatibility with diverse communication standards such as Ethernet, Fiber Channel, or proprietary protocols. This capability is advantageous for hybrid networks where newer crossbar technology must coexist with existing infrastructure. By enabling seamless communication, the analog crossbars ensure a smooth upgrade path for organizations transitioning to advanced switching architectures while maintaining operational continuity

In some embodiments, the device may include one or more redundant crossbars that may facilitate one or more of control signaling or data signaling when failover occurs. Failover may use redundant crossbars so that control traffic and/or data traffic may be maintained during failover, which is discussed in detail further below.

The DSP radix may be increased using an analog crossbar from M to M+R. There may be R alternative paths to connect multiple inputs to multiple outputs. This may allow for the resolution of up to R failures per analog crossbar chip (including input/output buffers and/or switch failures). This may also provide for hitless switch reconfiguration by allowing two inputs to disturb two outputs.

Redundant crossbars may serve at least two purposes. First, redundant crossbars may be used for OOB traffic. Second, redundant crossbars may be used for IB traffic. In one example, R may be two. In this scenario, one of the redundant crossbars may be used for OOB traffic to DSPs, and another redundant crossbar may be used for IB traffic. The modules may have an OOB transceiver (e.g., using 10 Gbps SERDES, SPI., or the like).

In some embodiments, redundant crossbars in the AECS 100 provide advantageous failover mechanisms to maintain control and data traffic during failures. By supporting OOB and IB signaling, traffic prioritization, path diversity, distributed recovery, and adaptive failover, these crossbars enhance the reliability and robustness of the system. These features contribute to efficient and resilient performance in dynamic and demanding network environments, which are described in detail below.

Redundant crossbars, as illustrated in FIG. 1 and FIG. 2, provide advantageous failover mechanisms to maintain uninterrupted traffic control and data signaling during failures. These crossbars enable alternate routing of both control and data traffic when primary crossbars experience issues such as input/output buffer malfunctions, hardware faults, or signal degradation. This capability is beneficial for ensuring that the AECS 100 continues to function reliably in high-availability network environments.

In FIG. 2, circuit 200 demonstrates the configuration of multiple redundant paths within the analog crossbar. Each input 205 can dynamically connect to one or more outputs 210 using redundant crossbars, which act as backup pathways during primary path failures. The switch controller 130 monitors the operational state of primary crossbars 120a, 120b, and, upon detecting a fault, initiates a failover by reconfiguring connections to utilize redundant paths. This process advantageously minimizes service disruptions by rapidly redirecting traffic.

To ensure control signaling is preserved during failover, redundant crossbars may be specifically designated for out-of-band (OOB) traffic. As shown in FIG. 1, OOB transceivers integrated with redundant crossbars provide a dedicated communication channel for the switch controller 130 to manage reconfiguration tasks. Operating at high speeds, such as 10 Gbps SERDES or higher, these transceivers allow real-time signaling between DSPs 110a, 110b, 110c, 110d and crossbars, ensuring that the system remains responsive during transitions.

Redundant crossbars also support in-band (IB) failover, allowing data traffic to continue flowing seamlessly. In FIG. 2, separate paths are maintained for OOB and IB traffic to prevent congestion during failover scenarios. For example, one redundant crossbar may be reserved for OOB signaling, while another is used exclusively for IB data traffic. This separation of responsibilities advantageously ensures that control operations do not interfere with ongoing data transmissions, preserving overall system performance.

Advanced traffic prioritization is enabled by the use of redundant crossbars. During failover, the switch controller 130 can dynamically allocate traffic based on predefined priorities. Critical traffic flows, such as real-time applications or high-priority control plane signaling, may be assigned to the most reliable redundant paths. This prioritization is beneficial for maintaining uninterrupted services, even when system resources are temporarily constrained.

As shown in FIG. 2, time-division multiplexing (TDM) can be implemented across redundant crossbars to efficiently manage traffic during failover. By allocating specific time slots for different traffic flows, the system ensures equitable access to redundant resources while minimizing conflicts. TDM is particularly effective in scenarios where multiple zones or applications share the same crossbar infrastructure, as it provides a structured approach to traffic management.

Redundant crossbars provide beneficial path diversity. Each input 205 can connect to multiple outputs 210 via alternative redundant paths, reducing dependency on any single crossbar. This diversity allows traffic to bypass faulty components without significant reconfiguration overhead. For instance, if a failure is localized to a specific DSP 110a or crossbar element, traffic can be rerouted through alternate paths while maintaining overall system integrity.

Distributed fault recovery may also be implemented using redundant crossbars. The AECS 100 leverages multiple DSPs and crossbars to distribute traffic across the network dynamically. If a failure occurs in one section, unaffected DSPs and crossbars can absorb the additional load, ensuring consistent performance. This distributed approach minimizes the impact of localized failures and enhances the scalability of the network.

Environmental monitoring and adaptive failover mechanisms further enhance the reliability of redundant crossbars. Sensors embedded within the crossbars and DSPs detect environmental changes such as temperature fluctuations, voltage irregularities, or signal degradation. Based on this feedback, the switch controller 130 proactively reassigns traffic to redundant paths before performance issues escalate, ensuring a seamless user experience.

To optimize power efficiency, redundant crossbars may operate in a low-power standby mode when not actively used for traffic. Upon detecting a failure in the primary path, these crossbars can be rapidly activated to handle the rerouted traffic. This energy-saving feature reduces operational costs while maintaining the system's readiness to address unexpected failures.

In some embodiments, additional analog crossbars may be used to communicate to one or more DSPs without blocking IB traffic. A switch controller may broadcast OOB to DSPs and analog crossbars. A switch controller may use OOB signaling to communicate with individual DSPs and/or analog crossbars. Time-division multiplexing (TDM) may be used to address a subset of DSPs and/or analog crossbars. OOB transceivers may be integrated in analog crossbars so that analog crossbars may be individually addressable and/or use TDM.

In some embodiments, analog crossbars may use real-time adaptive equalization to adjust analog crossbar performance in response to one or more of an environmental change or a signal degradation. Real-time adaptive equalization may be based on feedback from DSPs.

Described in further detail below, in some embodiments, analog crossbars may use programmable equalization which may be distributed at inputs, outputs, internal amplifiers, or as stand-alone passives. Equalization may be set by an on-chip controller (e.g., a switch controller) or an off-chip controller. Equalization may vary based on different crossbar configurations. Equalization may be calibrated and/or optimized for different crossbar configurations via an on-chip logic or controller or an off-chip logic or controller. Equalization may be optimized with feedback from channel performance of end-point DSPs (such as bit error rate (BER), signal-to-noise ratio (SNR), transmitter and dispersion eye closure quaternary (TDECQ), or the like). Equalization settings for different crossbar configurations may be stored in memory. Crossbar configurations and equalization may be changed synchronously or asynchronously.

The analog crossbars may facilitate amplification. For example, an input signal may be amplified before exiting as an output signal. Amplification in the context of the analog crossbars 120a, 120b, as illustrated in FIGS. 1-3, refers to the enhancement of signal strength to ensure reliable communication between inputs and outputs. This capability is particularly useful in high-speed networking environments where signal attenuation and noise can degrade data integrity over long transmission paths or through complex switching architectures. By incorporating amplification at advantageous points within the crossbars, the AECS 100 maintains robust signal fidelity across its communication pathways.

For example, in some embodiments, the amplification functionality may be integrated with the DSPs 110a, 110b, 110c, 110d and the analog crossbars 120a, 120b. Each DSP provides feedback to the crossbars regarding the quality of transmitted signals, including metrics such as signal amplitude and noise levels. Based on this feedback, the crossbars dynamically adjust amplification levels to compensate for observed signal degradation, ensuring that data arriving at the outputs retains its integrity and is within the acceptable threshold for further processing by the receiving devices.

As shown in FIG. 2, circuit 200 demonstrates the routing of signals from multiple inputs 205 to multiple outputs 210 through the crossbars. Amplification may occur at both the input and output stages of the crossbar. At the input stage, incoming signals can be amplified to mitigate initial losses caused by transmission over long distances or through noisy environments. This ensures that the signal strength is adequate for further processing within the crossbar. At the output stage, amplification can enhance the signal to ensure its integrity as it travels to its destination, whether another DSP, a client system, or a subsequent crossbar.

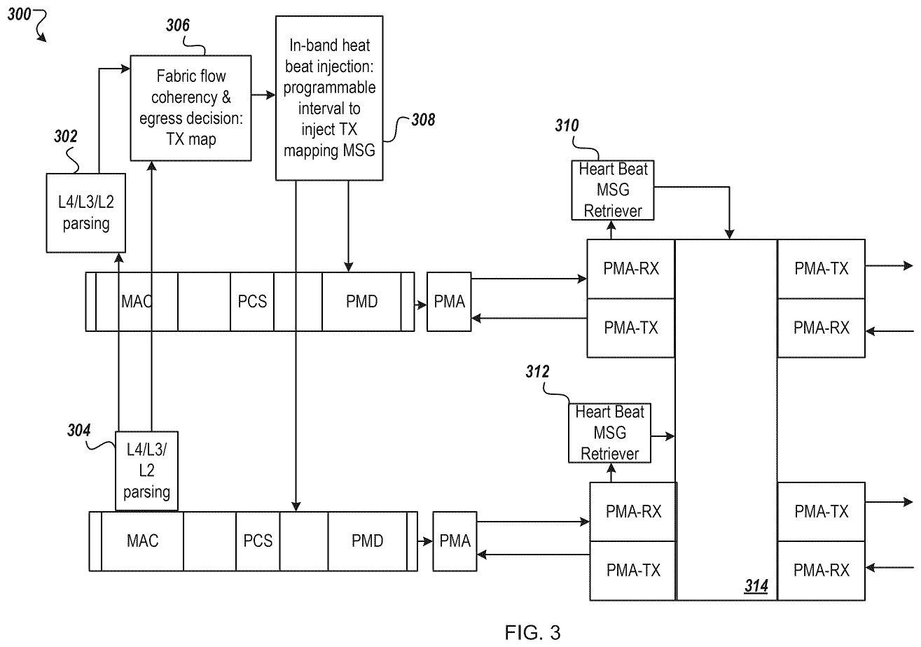

The amplification process in the analog crossbars 120a, 120b is not static; rather, it is adaptive and real-time. In FIG. 3, the centralized egress decision maker 306 plays a role in determining when and how amplification should be applied. For example, during high-traffic periods, the decision maker may instruct the crossbars to increase amplification levels to prevent signal degradation caused by congestion or interference. Conversely, during low-traffic periods, amplification levels may be reduced to conserve energy while maintaining sufficient signal quality.

Amplification in the analog crossbars also supports advanced features such as multicasting and broadcasting. As described in FIG. 2, when a single input 205 is connected to multiple outputs 210, the signal may experience splitting losses that reduce its strength at each output. To address this, the crossbars apply amplification to each output path, ensuring that the signal remains strong and reliable across all recipients. This capability is particularly advantageous for scenarios such as distributing control signals to multiple DSPs or broadcasting system updates across security zones.

Environmental factors such as temperature fluctuations or electromagnetic interference can also impact signal strength. To address these challenges, the analog crossbars 120a, 120b incorporate sensors to monitor environmental conditions and dynamically adjust amplification levels accordingly. For example, during periods of high electromagnetic interference, the crossbars may increase amplification to counteract the noise, ensuring that the transmitted signal remains clear and interpretable by the receiving devices.

The amplification capabilities in the analog crossbars 120a, 120b contribute to the overall efficiency and reliability of the AECS 100. By dynamically enhancing signal strength in response to real-time feedback and environmental conditions, the system ensures consistent performance across diverse and demanding network environments. These features make amplification an aspect of the crossbar's functionality, enabling it to support high-speed, high-fidelity data transmission in modern networking applications.

The analog crossbars may facilitate one or more of multicasting and/or broadcasting. Analog crossbars may support broadcast modes, allowing one input to distribute data to multiple outputs simultaneously without forming separate connections. Thus, an input lane may be connected to more than one output lane. By supporting a single input to connect to multiple outputs simultaneously, the crossbars enable efficient distribution of control signals or data streams to multiple recipients. This is particularly advantageous in scenarios such as synchronizing distributed DSPs, replicating configuration updates, or broadcasting high-priority alerts across the system. Optimization techniques, such as load balancing across multiple broadcast paths, can further improve the efficiency and scalability of multicast operations.

Analog crossbars may be synchronized to one or more of DSPs and/or the switch controller. Analog crossbars may be synchronized using one or more of Institute of Electrical and Electronics Engineers (IEEE) 1588 or a shared clock signal. The analog crossbars may maintain a time base which may be synchronous with a reference. The analog crossbars may use on-chip or off-chip controller and/or logic for configuring, synchronizing, and/or managing the analog crossbar. The crossbar may have heartbeat functionality to confirm operational status. The crossbar may switch among a set of states in a programmable pattern.

A device may include DSPs and analog crossbars in communication with DSPs. The analog crossbars may: (i) use one or more of equalization and/or amplification in analog crossbars, and/or (ii) optimize an analog crossbar configuration based on feedback from DSPs.

As illustrated in the diagram 300 in FIG. 3, an inline wire speed parser 302, 304 may receive packet metadata used to egress a connection for an input port. A centralized egress decision maker 306 may, based on metadata from the input ports, process the parser data and determine a correspondence between different input ports and different output ports (i.e., generate a transmission map). A centralized in-band heartbeat message injector 308 may inject the transmission map message packet into an input data flow (e.g., like a Wi-Fi® beacon) to form a programmable interval for the transmission map. At the input port of the analog switch 314, a heartbeat message retriever 310, 312 may recover the transmission map and generate a signal to switch the analog multiplexer to direct an input port traffic to an output port. The output port incoming traffic may be directed to the input port.

In addition or alternatively, the AECS may be an optical circuit switch (OCS). Thus, any technique suitable for an AECS may be applied to an OCS.

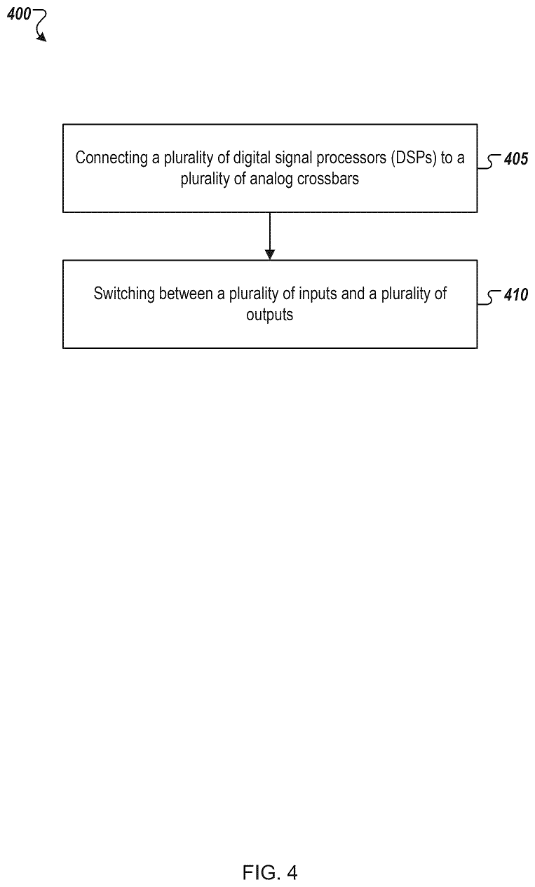

FIG. 4 illustrates a process flow of an example method 400 for an analog crossbar, in accordance with at least one example described in the present disclosure. The method 400 may be arranged in accordance with at least one example described in the present disclosure.

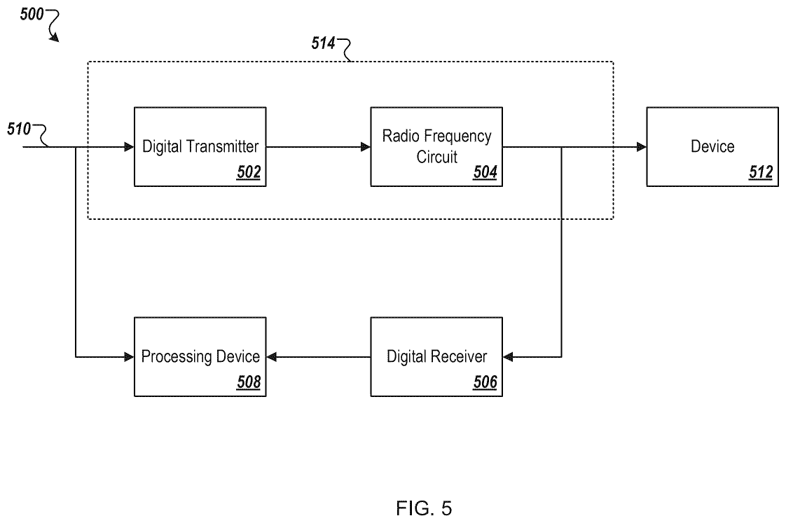

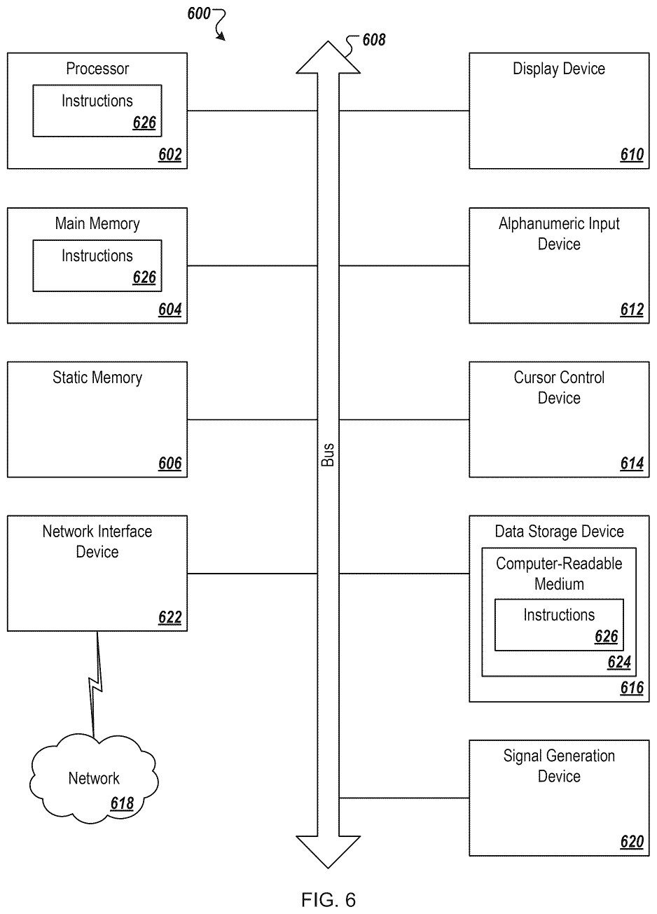

The method 400 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 400 may begin at block 405 where the processing logic may connect digital signal processors (DSPs) to analog crossbars.

At block 410, the processing logic may switch between multiple inputs and multiple outputs.

The processing logic may determine a crossbar configuration for analog crossbars based on feedback from DSPs. The processing logic may adjust a crossbar configuration dynamically based on a crossbar state. The processing logic may use OOB signaling to facilitate system management traffic. The processing logic may use one or more redundant crossbars to facilitate one or more of control signaling or data signaling when failover occurs. The processing logic may use real-time adaptive equalization to adjust analog crossbar performance in response to one or more of an environmental change or a signal degradation. The processing logic may use amplification at analog crossbars. The processing logic may multicast at analog crossbars. The processing logic may broadcast at analog crossbars. The processing logic may synchronize analog crossbars to one or more of DSPs or a switch controller.

Referring now to FIGS. 1-3 in conjunction with FIG. 4, in some embodiments, real-time equalization in the analog crossbars 120a, 120b provides advanced capabilities for optimizing signal quality and performance across AECS 100. As illustrated in FIG. 1, DSPs 110a, 110b, 110c, 110d may continuously monitor signal integrity metrics such as bit error rate (BER), signal-to-noise ratio (SNR), and transmitter and dispersion eye closure quaternary (TDECQ) from incoming and outgoing data streams. This feedback is dynamically communicated to the analog crossbars 120a, 120b, which adjust their equalization settings to maintain optimal performance. These real-time adjustments ensure that signal degradation due to environmental changes, such as temperature fluctuations or cable wear, is mitigated promptly.

In some embodiments, as shown in FIG. 2, circuit 200 demonstrates how the crossbar IC's equalization capabilities are distributed across multiple inputs 205 and outputs 210. Each input 205 and output 210 may feature programmable equalizers that adapt individually to the characteristics of the connected devices or transmission lines. This per-path equalization allows the crossbar to handle diverse signal conditions simultaneously, enabling efficient switching between multiple input and output pairs without compromising signal fidelity.

In some embodiments, the analog crossbars 120a, 120b incorporate adaptive equalization algorithms that leverage machine learning models to predict and compensate for signal degradation proactively. For example, based on historical patterns and real-time metrics received from DSPs 110a, 110b, 110c, 110d, the crossbars may preemptively adjust equalizer tap settings to avoid performance bottlenecks. This predictive capability enhances system reliability, particularly in high-traffic environments where signal conditions can change rapidly.

In FIG. 3, the centralized egress decision maker 306 may integrate equalization feedback into its determination of crossbar configurations. By considering real-time equalization states, the decision maker ensures that connections are routed through the most optimized paths. Additionally, the centralized in-band heartbeat message injector 308 may include equalization-related metadata, enabling synchronized updates across all crossbars and DSPs. This coordination ensures consistency in equalization adjustments, even in distributed or asynchronous operation modes.

Real-time equalization settings in the analog crossbars 120a, 120b may be stored in non-volatile memory for quick reconfiguration during failover or dynamic switching events. As described in FIG. 2, each crossbar may retain a library of pre-calibrated equalization profiles tailored to specific input-output pairs or operational conditions. This library enables the crossbars to recover their optimal configuration almost instantaneously after a state change or system reboot, minimizing downtime and ensuring seamless operation.

In some embodiments, analog crossbars 120a, 120b support advanced equalization calibration workflows that are either fully autonomous or partially supervised by the switch controller 130. Autonomous workflows involve real-time adjustments based solely on DSP feedback, while supervised workflows may incorporate directives from the switch controller to enforce system-wide performance objectives. For example, the switch controller may prioritize equalization adjustments for high-priority traffic zones, ensuring that data streams maintain superior signal quality.

The crossbars may also employ distributed equalization strategies, wherein adjustments are coordinated across multiple crossbars and DSPs in a shared configuration. For example, if signal degradation is detected at one input 205 of the crossbar, adjustments to other connected paths may be synchronized to maintain overall system balance. This distributed approach is particularly beneficial in scenarios involving multicast or broadcast operations, as illustrated in FIG. 3, where a single input may simultaneously drive multiple outputs.

Environmental resilience is a feature of the real-time equalization system. Analog crossbars 120a, 120b may incorporate sensors to monitor temperature, voltage levels, and other environmental factors that impact signal integrity. The equalization algorithms consider these parameters in conjunction with DSP feedback to fine-tune performance dynamically. This capability allows the crossbars to maintain consistent performance even in challenging operating environments, such as outdoor installations or high-density data centers.

Real-time equalization in the analog crossbars 120a, 120b extends beyond signal fidelity to encompass power efficiency. For example, equalization levels may be dynamically adjusted to balance signal quality and power consumption. In low-traffic scenarios, equalizers may operate at reduced intensity to conserve energy while still maintaining adequate signal integrity. Conversely, during peak traffic conditions, equalization levels may be heightened to ensure maximum throughput and reliability

Beyond equalization, in some embodiments, the analog crossbars can leverage real-time traffic analytics from the switch controller 130 to adjust input-output mappings dynamically. For example, during peak traffic periods, the crossbars can allocate additional bandwidth to high-priority zones or reroute lower-priority traffic to less congested paths. This adaptability ensures that traffic is distributed efficiently, reducing bottlenecks and improving overall system performance.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a block diagram of an example communication system 500 configured for an analog crossbar, in accordance with at least one example described in the present disclosure. The communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may be configured to obtain a baseband signal. For example, as described herein, the transceiver 514 may be configured to generate a baseband signal and/or receive a baseband signal from another device. In some examples, the transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an IEEE 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 514 may be configured to generate a baseband signal for transmission. In these and other examples, the transceiver 514 may be configured to transmit the baseband signal to another device, such as the device 512.

In some examples, the device 512 may be configured to receive a transmission from the transceiver 514. For example, the transceiver 514 may be configured to transmit a baseband signal to the device 512.

In some examples, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a DSP, network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

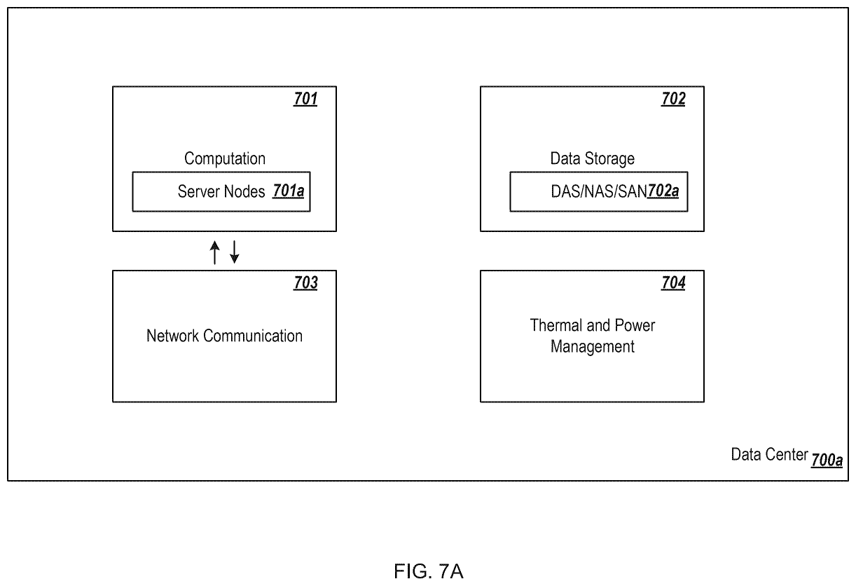

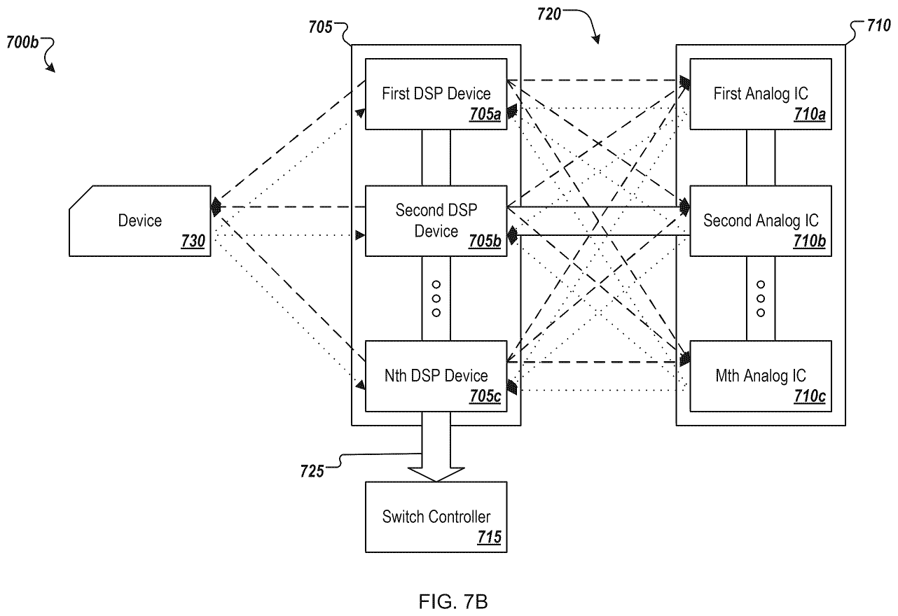

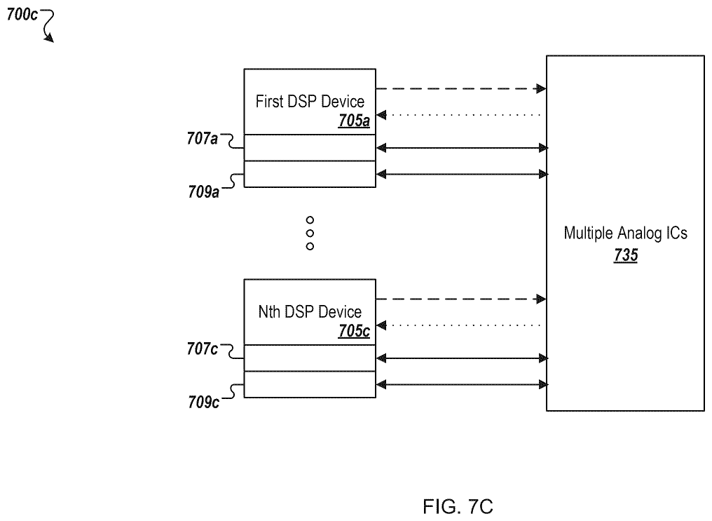

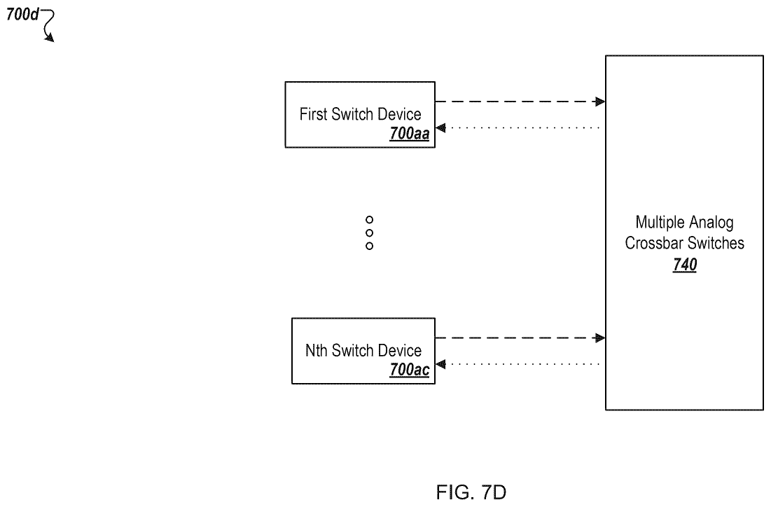

As illustrated in FIG. 7, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5 ns, 10 ns, or the like switching). Alternatively, or additionally, the switch device 700b may reconfigure without the use of retiming such that each lane of the multiple lanes included therein may use less than 50 mW of power. For example, each lane of the multiple lanes may support 100 G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, all within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic 720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for a size communication, by adjusting the switch devices 700b and/or the multiple analog crossbar switches 740 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs); and
a plurality of analog crossbars in communication with the plurality of DSPs,
wherein the plurality of analog crossbars are operable to dynamically switch between a plurality of inputs and a plurality of outputs based on traffic demands or network conditions.

2. The device of claim 1, wherein the plurality of analog crossbars are operable to:
determine and adapt crossbar configurations based on real-time feedback from the plurality of DSPs, including signal integrity metrics including bit error rate (BER) or signal-to-noise ratio (SNR).

3. The device of claim 1, wherein the plurality of analog crossbars are operable to:
facilitate dynamic configuration adjustments based on a crossbar state, including stored equalization profiles, active performance metrics, or synchronization information.

4. The device of claim 1, wherein the plurality of analog crossbars are operable to:
use out-of-band (OOB) signaling to facilitate system management traffic, including synchronization, control updates, and diagnostic communication.

5. The device of claim 1, further comprising:
one or more redundant crossbars operable to provide alternate paths for control signaling or data signaling during failover events, ensuring uninterrupted communication.

6. The device of claim 1, wherein the plurality of analog crossbars are operable to:
implement real-time adaptive equalization to adjust analog crossbar performance in response to environmental changes, signal degradation, or traffic variations.

7. The device of claim 1, wherein the plurality of analog crossbars are operable to provide signal amplification or equalization, optimizing signal strength for enhanced performance across input-output pairs.

8. The device of claim 1, wherein the plurality of analog crossbars are operable to:
support multicasting and broadcasting, allowing a single input to communicate with multiple outputs simultaneously.

9. The device of claim 1, wherein the plurality of analog crossbars are synchronized to one or more of:
the plurality of DSPs or a switch controller using synchronization techniques including IEEE 1588 or shared clock signals.

10. A method comprising:
connecting a plurality of digital signal processors (DSPs) to a plurality of analog crossbars; and
dynamically switching between a plurality of inputs and a plurality of outputs based on traffic demands or network conditions.

11. The method of claim 10, further comprising:
determining a crossbar configuration for the plurality of analog crossbars based on real-time feedback from the plurality of DSPs, including signal integrity metrics.

12. The method of claim 10, further comprising:
dynamically adjusting a crossbar configuration based on a crossbar state, including stored equalization profiles, active performance metrics, or synchronization information.

13. The method of claim 10, further comprising:
using out-of-band (OOB) signaling to facilitate system management traffic, including synchronization, control updates, and diagnostic communication.

14. The method of claim 10, further comprising:
using one or more redundant crossbars to provide alternate paths for control signaling or data signaling during failover events.

15. The method of claim 10, further comprising:
using real-time adaptive equalization to adjust analog crossbar performance in response to environmental changes, signal degradation, or traffic variations.

16. The method of claim 10, further comprising:
providing signal amplification or equalization at the plurality of analog crossbars to optimize signal strength for enhanced performance.

17. The method of claim 10, further comprising performing multicasting at the plurality of analog crossbars or broadcasting at the plurality of analog crossbars to allow a single input to communicate with multiple outputs simultaneously.

18. The method of claim 10, further comprising:
synchronizing the plurality of analog crossbars to one or more of the plurality of DSPs or a switch controller using synchronization techniques including IEEE 1588 or shared clock signals.

19. A device, comprising:
a plurality of digital signal processors (DSPs); and
a plurality of analog crossbars in communication with the plurality of DSPs, wherein the plurality of analog crossbars are operable to use one or more of equalization or amplification to enhance performance.

20. The device of claim 19, wherein the plurality of analog crossbars are further operable to optimize an analog crossbar configuration based on feedback from the plurality of DSPs, including traffic conditions or signal integrity metrics.
